(19) United States
(12) Patent Application Publication
(10) Pub. No.: US 2006/0067169 A1
(43) Pub. Date: Mar. 30, 2006

(54) Clock Assembly that is assembled easily

(75) Inventor: Shanker Mo, Taichung (TW)

Correspondence Address: NIKOLAI & MERSEREAU, P.A., 900 SECOND AVENUE SOUTH, SUITE 820, MINNEAPOLIS, MN, 55402, US

(73) Assignee: Centre Clock Industry Co., Ltd., Taichung (TW)

(21) Appl. No.: 10/951,115

(22) Filed: Sep. 27, 2004

(51) Int. Cl. G04B 37/00; G04B 19/00

(52) U.S. Cl. 368/223; 368/276

(57) ABSTRACT

A clock assembly includes a main body, a decorative scale panel mounted on the main body, and a cover mounted on the main body and rested on the decorative scale panel to retain the decorative scale panel on the main body. Thus, when the decorative scale panel is mounted on the main body, the main frame of the decorative scale panel is directly received in the main body and each of the scale indicators of the decorative scale panel is received in a respective one of the mounting grooves of the main body, so that the decorative scale panel is mounted on the main body easily and conveniently, thereby facilitating an operator mounting the clock assembly.

### BACKGROUND OF THE INVENTION

1. Field of the Invention

The present invention relates to a clock assembly, and more particularly to a clock assembly that is assembled easily and conveniently.

2. Description of the Related Art

A conventional clock assembly in accordance with the prior art shown in FIG. 4 comprises a main body 1 having a peripheral wall formed with a plurality of screw bores 13, and a plurality of scale indicators 14 each mounted on the main body 1 and each having a first end formed with an outer thread 140 screwed into the respective screw bore 13 of the main body 1 and a second end provided with an ornament 141.

However, when the scale indicators 14 are mounted on the main body 1, the operator needs to screw the outer thread 140 of each of the scale indicators 14 into the respective screw bore 13 of the main body 1 respectively, thereby causing inconvenience in mounting the conventional clock assembly. In addition, the screw bores 13 of the main body 1 are spaced from each other equally, thereby increasing costs of fabrication.

### SUMMARY OF THE INVENTION

In accordance with the present invention, there is provided a clock assembly, comprising:
a main body;
a decorative scale panel mounted on the main body; and
a cover mounted on the main body and rested on the decorative scale panel to retain the decorative scale panel on the main body.

The primary objective of the present invention is to provide a clock assembly that is assembled easily and conveniently.

Another objective of the present invention is to provide a clock assembly, wherein when the decorative scale panel is mounted on the main body, the main frame of the decorative scale panel is directly received in the main body and each of the scale indicators of the decorative scale panel is received in a respective one of the mounting grooves of the main body, so that the decorative scale panel is mounted on the main body easily and conveniently, thereby facilitating an operator mounting the clock assembly.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a clock assembly in accordance with the preferred embodiment of the present invention;

FIG. 2 is an exploded perspective view of the clock assembly as shown in FIG. 1;

FIG. 3 is a side plan cross-sectional view of the clock assembly as shown in FIG. 1; and

FIG. 4 is a perspective view of a conventional clock assembly in accordance with the prior art.

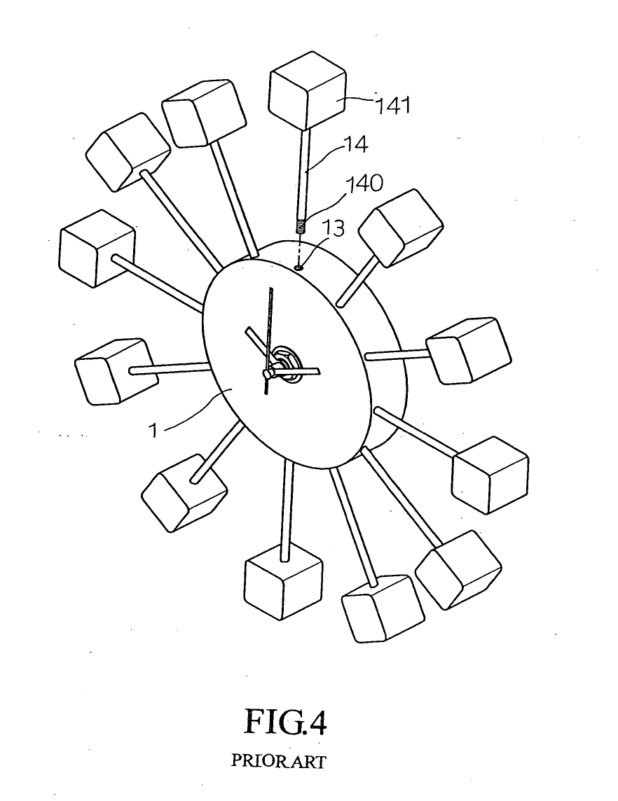

### DETAILED DESCRIPTION OF THE INVENTION

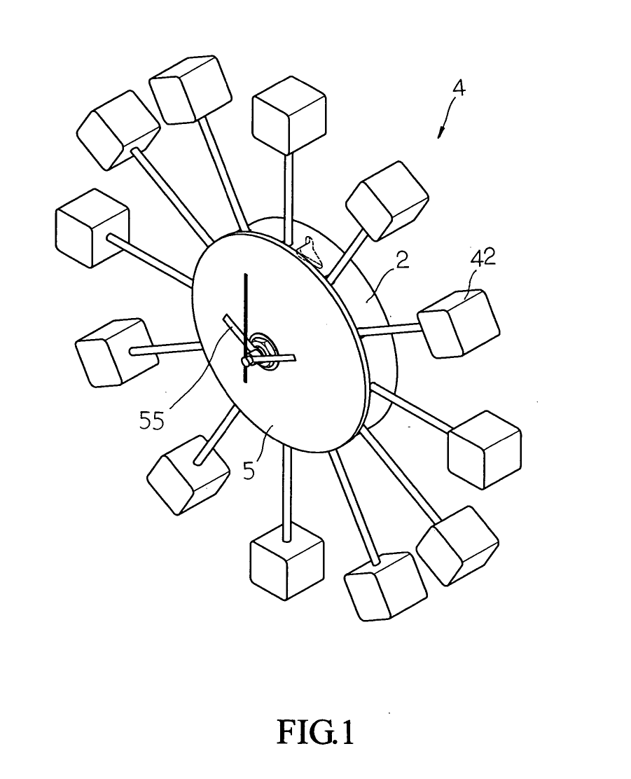

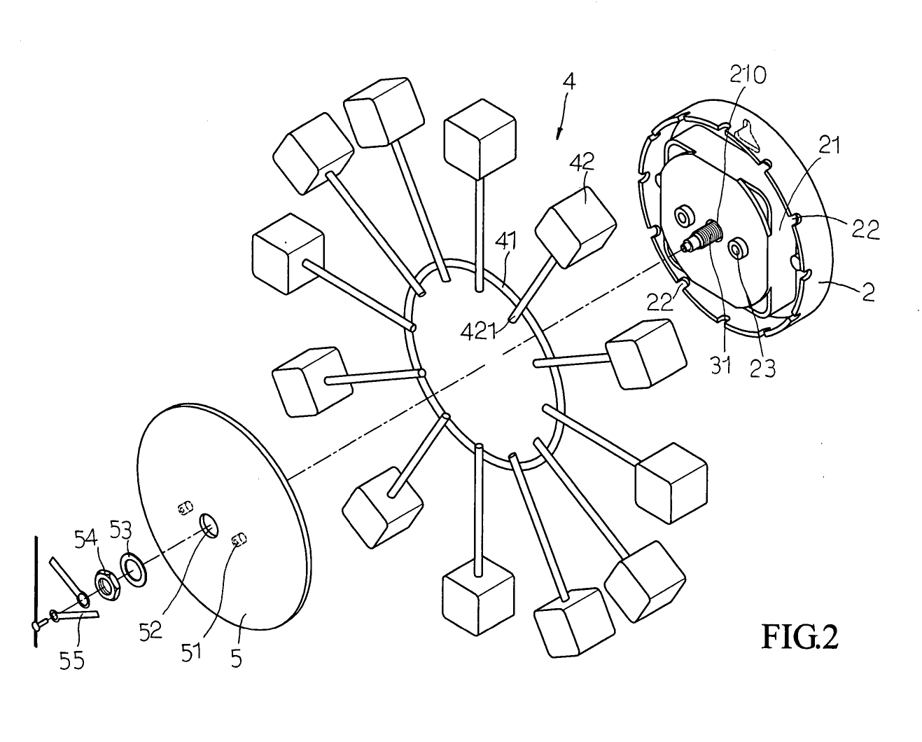

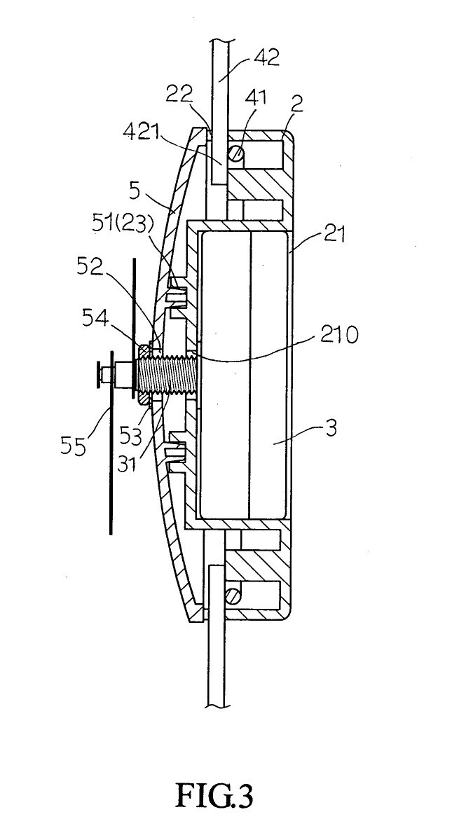

Referring to FIGS. 1-3, a clock assembly in accordance with the preferred embodiment of the present invention comprises a main body 2, a decorative scale panel 4 mounted on the main body 2, and a cover 5 mounted on the main body 2 and rested on the decorative scale panel 4 to retain the decorative scale panel 4 on the main body 2.

The main body 2 has an inside formed with a receiving seat 21 for mounting a tumbler 3 which has a central shaft 31 extended through a central hole 210 of the receiving seat 21 of the main body 2 and a central hole 52 of the cover 5 and combined with a washer 53, a nut 54 and a plurality of pointers 55.

The receiving seat 21 of the main body 2 has a side formed with two spaced positioning holes 23, and the cover 5 has a side formed with two spaced positioning stubs 51 each inserted into a respective one of the two positioning holes 23 of the receiving seat 21 of the main body 2, so that the cover 5 is secured on the receiving seat 21 of the main body 2.

The decorative scale panel 4 includes a circular main frame 41 mounted in the main body 2 and rested on a periphery of the receiving seat 21 of the main body 2, and a plurality of scale indicators 42 each protruding outward from the main body 2 and each having a distal end 421 extended into the main body 2 and mounted on the main frame 41.

The main frame 41 of the decorative scale panel 4 has a shape matching that of a peripheral wall of the main body 2 and has a diameter smaller than that of the main body 2, so that the main frame 41 of the decorative scale panel 4 is received in the main body 2.

The distal end 421 of each of the scale indicators 42 of the decorative scale panel 4 is secured on the main frame 41 and has a portion extended into an inside of the main frame 41 so as to enhance the strength of each of the scale indicators 42.

The main body 2 has a peripheral wall formed with a plurality of arc-shaped mounting grooves 22 for mounting a respective one of the scale indicators 42 of the decorative scale panel 4.

Accordingly, when the decorative scale panel 4 is mounted on the main body 2, the main frame 41 of the decorative scale panel 4 is directly received in the main body 2 and each of the scale indicators 42 of the decorative scale panel 4 is received in a respective one of the mounting grooves 22 of the main body 2, so that the decorative scale panel 4 is mounted on the main body 2 easily and conveniently, thereby facilitating an operator mounting the clock assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A clock assembly, comprising:
a main body;
a decorative scale panel mounted on the main body and protruded outward from an outer periphery of the main body; and
a cover mounted on the main body and rested on the decorative scale panel to retain the decorative scale panel on the main body, with the decorative scale panel located between the main body and the cover.

2. The clock assembly in accordance with claim 1, wherein the main body has an inside formed with a receiving seat having a first side formed with an open wall and a second side formed with a closed wall.

3. The clock assembly in accordance with claim 2, wherein the closed wall of the receiving seat of the main body has a side formed with two spaced positioning holes, and the cover is substantially disk-shaped and has a side formed with two spaced positioning stubs each inserted into a respective one of the two positioning holes of the receiving seat of the main body, so that the cover is secured on the receiving seat of the main body.

4. The clock assembly in accordance with claim 2, further comprising a tumbler mounted in the receiving seat of the main body and having a central shaft extended through a central hole formed in the closed wall of the receiving seat of the main body and a central hole of the cover and combined with a washer, a nut and a plurality of pointers.

5. The clock assembly in accordance with claim 1, wherein the decorative scale panel includes a ring-shaped main frame mounted in the main body, and a plurality of scale indicators each protruding radially outward from the outer periphery of the main body and each having a rod-shaped distal end extended into the main body and mounted on the main frame.

6. (canceled)

7. The clock assembly in accordance with claim 5, wherein the main frame of the decorative scale panel is rested on a periphery of a receiving seat of the main body.

8. (canceled)

9. (canceled)

10. The clock assembly in accordance with claim 5, wherein the distal end of each of the scale indicators of the decorative scale panel is secured on the main frame.

11. The clock assembly in accordance with claim 5, wherein the distal end of each of the scale indicators of the decorative scale panel has a portion extended into an inside of the main frame.

12. The clock assembly in accordance with claim 5, wherein the main body has an open side having a peripheral wall formed with a plurality of mounting grooves to allow passage of the distal end of each of the scale indicators of the decorative scale panel.

13. The clock assembly in accordance with claim 12, wherein each of the mounting grooves of the main body is substantially arc-shaped.

14. The clock assembly in accordance with claim 5, wherein the distal end of each of the scale indicators of the decorative scale panel is protruded radially inward from an inner periphery of the main frame.
